(19) United States
(12) Patent Application Publication
(10) Pub. No.: US 2009/0007874 A1
(43) Pub. Date: Jan. 8, 2009

(54) AIR INTAKE DEVICE FOR MULTI-CYLINDER INTERNAL COMBUSTION ENGINE

(75) Inventor: Kazuyoshi ABE, Susono-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 12/137,797

(22) Filed: Jun. 12, 2008

(30) Foreign Application Priority Data
Jul. 5, 2007 (JP) 2007-177705

(51) Int. Cl. F02M 35/104

(52) U.S. Cl. 123/184.47

(57) ABSTRACT

An air intake device includes: a surge tank 14 having an internal space divided into a first space and a second space; a first intake manifold 20 including a plurality of intake branch pipes 16 protruding from the surge tank 14 via a funnel 18 and communicating with the first space, the first intake manifold 20 supplying air to cylinders on a first of two cylinder banks; and a second intake manifold 22 including a plurality of intake branch pipes 16 protruding from the surge tank 14 via the funnel 18 and communicating with the second space, the second intake manifold 22 supplying air to cylinders on a second of the two cylinder banks. The funnel 18 has a substantially rectangular transverse cross-sectional shape.

### BACKGROUND OF THE INVENTION

1. Field of the Invention

The present invention relates to an air intake device for a multi-cylinder internal combustion engine.

2. Background Art

In air intake devices of V-type engines, a widely used arrangement includes an integrated surge tank for left and right banks disposed upwardly of the engine. FIG. 7 is a cross-sectional view showing a typical arrangement of such an air intake device for a V-type engine. Referring to FIG. 7, the air intake device includes a first intake manifold 102 and a second intake manifold 104, each having a plurality of intake branch pipes protruding from a surge tank 100 via a funnel 101. The first intake manifold 102 is connected to a first bank of the V-type engine, while the second intake manifold 104 is connected to a second bank of the V-type engine. The surge tank 100 has an internal space that is divided into an upper space 106 and a lower space 108. The first intake manifold 102 is in communication with the upper space 106, while the second intake manifold 104 is in communication with the lower space 108.

FIGS. 8A and 8B are views showing a mounting space of such an air intake device of the V-type engine. FIG. 8A is a view as viewed from the front of a vehicle. FIG. 8B is a view as viewed from a side of the vehicle. Referring to FIGS. 8A and 8B, the air intake device of the V-type engine is disposed in a clearance between the engine and an engine hood. There is a need for a lower engine hood from a vehicle styling viewpoint. Accordingly, there are stringent restrictions on the height of the surge tank in the air intake device of the V-type engine. There is also a recent need for an impact absorbing space for pedestrian protection, which requires that the surge tank be built even further thinly.

Japanese Patent Laid-open No. 2005-325696 discloses an air intake device adapted such that an upper space of the surge tank has a front end disposed rearwardly in the vehicle of a front end of a lower space of the surge tank. This is done to have a lower surge tank height particularly at the forward side of the vehicle, given an engine hood configuration that is lower in height toward a front side thereof.

Including the above-mentioned document, the applicant is aware of the following documents as a related art of the present invention.
[Patent Document 1]

Japanese Patent Laid-open No. 2005-325696
[Patent Document 2]

Japanese Utility Model Laid-open No. Shou 61-184857

Referring to FIG. 7, the surge tank 100 has a partition plate 110 that separates the upper space 106 from the lower space 108. FIG. 9 is a perspective view showing schematically the surge tank 100, taken from the left side of FIG. 7. As described earlier, there is a need for reduction in thickness of the surge tank 100. It is nonetheless necessary to give the funnel 101 a diameter sufficiently comparable to a flow rate. To make the surge tank 100 thinner, therefore, it is necessary to bring the funnel 101 of the first intake manifold 102 closer to the funnel 101 of the second intake manifold 104 to thereby narrow a gap therebetween as shown in FIG. 9. As a result, the partition plate 110 becomes wavy in areas near the funnel 101 as shown by an arrow A of FIG. 7 and in FIG. 9. This poses a problem in that the wavy portion of the funnel 101 disturbs an air flow to produce intake resistance, leading to reduced air intake efficiency.

Another problem is that, for want of a sufficient space for the funnel 101 of each intake branch pipe, part of the funnel 101 of each intake branch pipe is lost at portions indicated by an arrow B and an arrow C of FIG. 9. This again leads to reduced air intake efficiency because air in the surge tank 100 cannot be made to flow smoothly into each intake branch pipe.

The surge tank 100 shown in FIG. 7 includes a variable valve 112 that opens or closes the upper space 106 and the lower space 108. With the variable valve 112 in a closed position, the upper space 106 and the lower space 108 each function as an independent tank volume. With the variable valve 112 opened, on the other hand, the upper space 106 and the lower space 108 communicate with each other as shown in FIG. 10, the upper space 106 and the lower space 108 functioning as an integrated tank volume.

Generally speaking, a small tank volume improves torque in low to middle speed regions and response, while reducing torque in a high speed region. A large tank volume, on the other hand, improves torque in the high speed region and reduces torque in the low to middle speed regions.

The variable valve 112 is provided in light of the above-described situation. Specifically, torque can be improved through an entire speed region by closing the variable valve 112 in the low to middle speed regions and opening the variable valve 112 in the high speed region.

Referring to FIG. 10, in the surge tank 100 of the known art, a vane of the variable valve 112 serves as resistance to flow to each intake branch pipe when the variable valve 112 is open, resulting in reduced air intake efficiency. Referring to FIG. 11, a substantially small opening area between the upper space 106 and the lower space 108 poses a problem of the upper space 106 and the lower space 108 being inability to be sufficiently integrated with each other. To make this substantial opening area larger, the vane of the variable valve 112 is made to open to an angle near 90°. This, however, makes even smaller a gap between the vane of the variable valve 112 and a tank inner wall, resulting in even greater intake resistance. In this case, it is extremely difficult to have a larger gap between the vane of the variable valve 112 and the tank inner wall because of restrictions on the height of the surge tank 100.

### SUMMARY OF THE INVENTION

The present invention has been made to solve the foregoing problems and it is an object of the present invention to provide an air intake device of a multi-cylinder internal combustion engine capable of improving air intake efficiency of the engine having two cylinder banks.

The above object is achieved by an air intake device for a multi-cylinder internal combustion engine having two cylinder banks. The air intake device includes a tank having an internal space divided into a first space and a second space disposed downwardly of the first space. The tank has a partition plate and an opening disposed at a boundary between the first and second spaces. The air intake device also includes a first intake manifold including a plurality of intake branch pipes protruding from the tank via a funnel and communicating with the first space. The first intake manifold supplies air to cylinders on a first of the two cylinder banks. The air intake device further includes a second intake manifold including a plurality of intake branch pipes protruding from the tank via a funnel and communicating with the second space. The second intake manifold supplies air to cylinders on a second of the two cylinder banks. The funnel has a substantially rectangular transverse cross-sectional shape.

Alternately, the above object is achieved by the following air intake device. The air intake device includes a tank having an internal space divided into a first space and a second space. The tank has a partition plate and an opening disposed at a boundary between the first and second spaces. The air intake device also includes a first intake manifold including a plurality of intake branch pipes protruding from the tank and communicating with the first space. The first intake manifold supplies air to cylinders on a first of the two cylinder banks. The air intake device further includes a second intake manifold including a plurality of intake branch pipes protruding from the tank and communicating with the second space. The second intake manifold supplies air to cylinders on a second of the two cylinder banks. The air intake device further includes a first variable valve disposed in the first space. The first variable valve is displaced between a closed position, in which an effective volume of the first space is small, and an open position, in which the effective volume of the first space is large. The air intake device further includes a second variable valve disposed in the second space. The second variable valve is displaced between a closed position, in which an effective volume of the second space is small, and an open position, in which the effective volume of the second space is large.

Other objects and further features of the present invention will be apparent from the following detailed description when read in conjunction with the accompanying drawings.

### BRIEF DESCRIPTION OF THE DRAWINGS

FIG. 1 is a perspective view showing an air intake device according to a first embodiment of the present invention;

FIG. 2 is a cross-sectional view showing the air intake device shown in FIG. 1;

FIG. 3 is a perspective view showing schematically a surge tank as viewed from a left side in FIG. 2;

FIGS. 4A and 4B are plan views showing the intake branch pipes;

FIG. 5 shows a condition, in which a first variable valve and a second variable valve are open;

FIG. 6 compares the condition, in which the first variable valve and the second variable valve are closed, with the condition, in which the first variable valve and the second variable valve are open;

FIG. 7 is a cross-sectional view showing a conventional air intake device for a V-type engine;

FIGS. 8A and 8B are views showing a mounting space of an air intake device of the V-type engine;

FIG. 9 is a perspective view showing schematically a surge tank taken from the left side of FIG. 7;

FIG. 10 is a cross-sectional view showing the conventional air intake device for a V-type engine;

FIG. 11 is a cross-sectional view showing the conventional air intake device for a V-type engine; and

FIG. 12 is a cross-sectional view showing the conventional air intake device for a V-type engine.

### BEST MODE FOR CARRYING OUT THE INVENTION

Specific embodiments to which the present invention is applied will be described below with reference to the accompanying drawings. In each of the accompanying drawings, like reference numerals refer to like parts and duplicate descriptions are omitted as may be applicable.

### First Embodiment

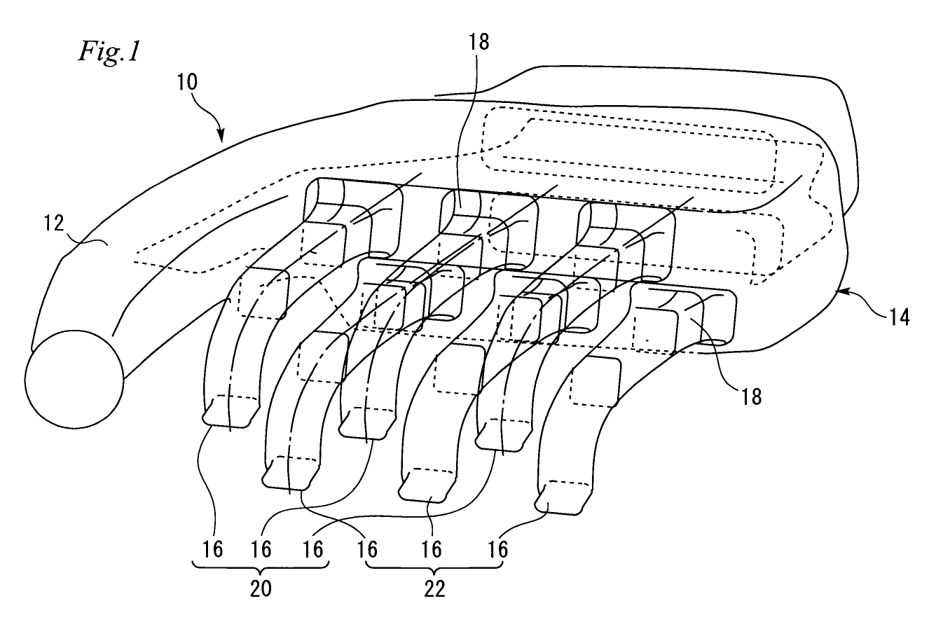

FIG. 1 is a perspective view showing an air intake device according to a first embodiment of the present invention. Referring to FIG. 1, an air intake device 10 according to the first embodiment of the present invention is for a V-type 6-cylinder engine, comprising an air collector 12 and a surge tank 14 disposed to continue from the air collector 12. Six intake branch pipes 16 for supplying air to cylinders of the V-type 6-cylinder engine are protruded from a side surface of the surge tank 14. A funnel 18 is formed at a portion of each intake branch pipe 16 adjacent the surge tank 14. Each of the intake branch pipes 16 and the funnels 18 have a rectangular transverse cross-sectional shape (shape of a cross section perpendicular to a longitudinal direction).

Of the six intake branch pipes 16, three constitute a first intake manifold 20 supplying air to cylinders on a first bank of the V-type 6-cylinder engine (hereinafter referred to simply as “engine”) and the rest three constitute a second intake manifold 22 supplying air to cylinders on a second bank of the engine.

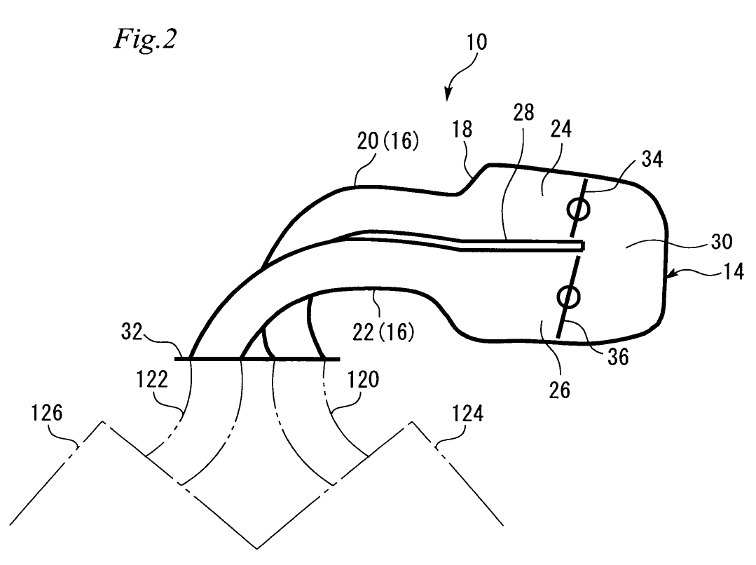

FIG. 2 is a cross-sectional view showing the air intake device 10 shown in FIG. 1. Referring to FIG. 2, the surge tank 14 has an internal space divided into a first space 24 and a second space 26. The first space 24 is disposed upward in the internal space, while the second space 26 is disposed downwardly of the first space 24. The first intake manifold 20 is in communication with the first space 24, while the second intake manifold 22 is in communication with the second space 26. The first space 24 and the second space 26 are separated from each other by a partition plate (bulkhead) 28 on a side of the intake manifolds. The first space 24 and the second space 26 are in communication with each other on a side of a wall opposite the side of the intake manifolds.

The first intake manifold 20 and the second intake manifold 22 are connected to a first bank 124 of the engine and a second bank 126 thereof via extension pipes 120, 122, respectively.

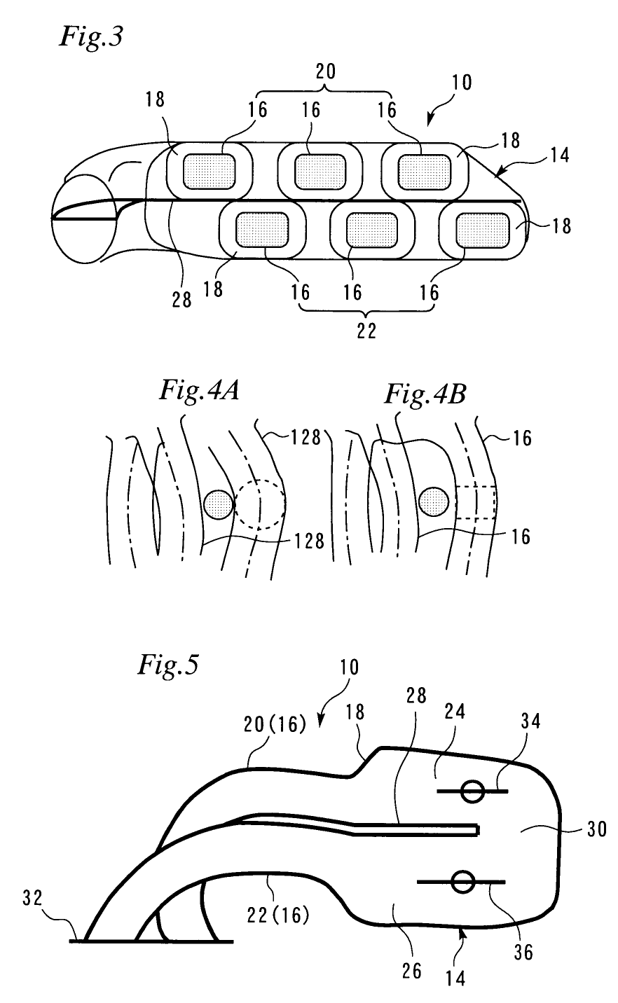

FIG. 3 is a perspective view showing schematically the surge tank 14 as viewed from a left side in FIG. 2. As described earlier, according to the first embodiment of the present invention, the funnel 18 at the portion of each intake branch pipe 16 adjacent the surge tank 14 has a rectangular transverse cross-sectional shape. This arrangement prevents a space for disposing each funnel 18 from overlapping each other even if the surge tank 14 is adapted to have a low height (thinning). This allows the partition plate 28 separating the first space 24 from the second space 26 to be shaped flatly including a portion near the funnel 18 as shown in FIGS. 2 and 3. As a result, suction resistance from the surge tank 14 into each intake branch pipe 16 (hereinafter referred to simply as “suction resistance”) can be reduced to improve air intake efficiency of the engine.

Because there is no overlap between the funnels 18, each funnel 18 can have a uniform taper throughout its entire periphery. This also contributes to reduction in the suction resistance. Pulsation of each cylinder can also be made stronger and uniform.

As such, the air intake device 10 according to the first embodiment of the present invention can achieve both a reduced thickness of the surge tank 14 and improved air intake efficiency. Accordingly, an engine hood of a vehicle can be made lower and the degree of freedom in styling can be enhanced. It is also possible to provide an impact absorbing space in an engine compartment, promoting pedestrian protection. In particular, according to the first embodiment of the present invention, the funnel 18 has a side, which extends in parallel with a height direction of the surge tank 14, shorter than a side orthogonal thereto, as shown in FIG. 3. This allows the surge tank 14 to be built even thinner without involving reduced air intake efficiency.

In the air intake device 10 according to the first embodiment of the present invention, not only the funnel 18, but also each intake branch pipe 16 has a rectangular transverse cross-sectional shape throughout its entire length. In this case, while the funnel 18 has a rectangular transverse cross-sectional shape, the intake branch pipe 16 has a square transverse cross-sectional shape as shown in FIG. 1. This achieves the following benefits.

Specifically, referring to FIG. 2, the first intake manifold 20 and the second intake manifold 22 have a flange 32 disposed at leading ends thereof. The flange 32 includes bolt holes formed therein for connection to the extension pipes 120, 122. There is a gap formed between the intake branch pipes 16, into which a tool for tightening bolts connecting the flange 32 to the extension pipes 120, 122 can be inserted at assembly. FIGS. 4A and 4B are plan views showing the intake branch pipes, in which crosshatched circles represent bolt positions. FIG. 4A is a view showing a comparative example having intake branch pipes 128 with a circular transverse cross-sectional shape. In FIG. 4A, the intake branch pipe 128 on the right is curved so as to form a gap for inserting the tool. The curve in the right intake branch pipe 128 increases pressure loss, which invites reduced air intake efficiency.

FIG. 4B shows the air intake device 10 according to the first embodiment of the present invention, having the intake branch pipes 16 with a square transverse cross-sectional shape. The intake branch pipe 16, having the square transverse cross-sectional shape, can have smaller vertical and horizontal widths as compared with the circular transverse cross-sectional shape having the same area. As a result, the gap into which the tool is inserted can be formed easily and the intake branch pipe 16 can have a milder curve as shown in FIG. 4B. As compared with the comparative example shown in FIG. 4A, therefore, the pressure loss can be minimized for the improved air intake efficiency.

Referring to FIG. 2, the air intake device 10 according to the first embodiment of the present invention has a first variable valve 34 and a second variable valve 36. The first variable valve 34 is disposed in the first space 24, while the second variable valve 36 is disposed in the second space 26. Both the first variable valve 34 and the second variable valve 36 according to the first embodiment of the present invention are butterfly valves. FIG. 2 shows a condition, in which the first variable valve 34 and the second variable valve 36 are closed. FIG. 5, on the other hand, shows a condition, in which the first variable valve 34 and the second variable valve 36 are open.

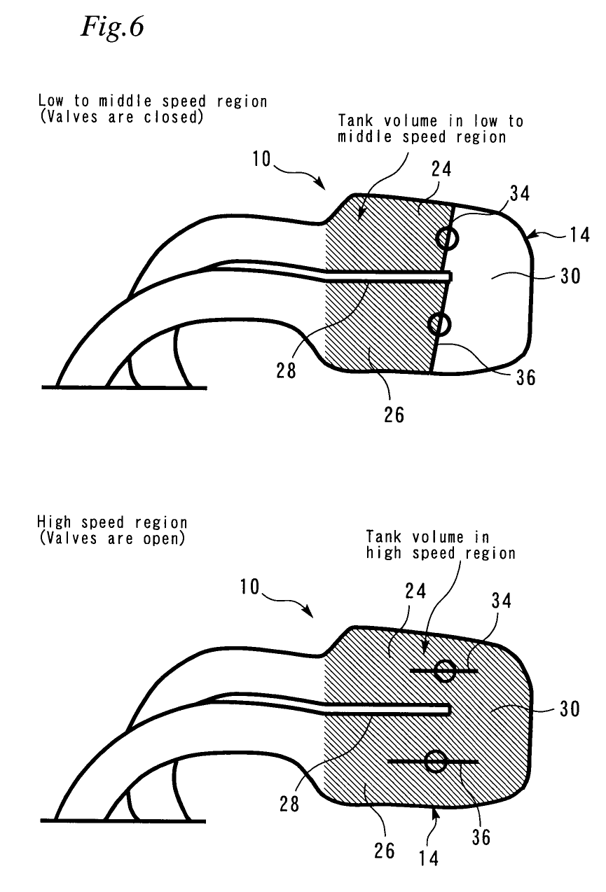

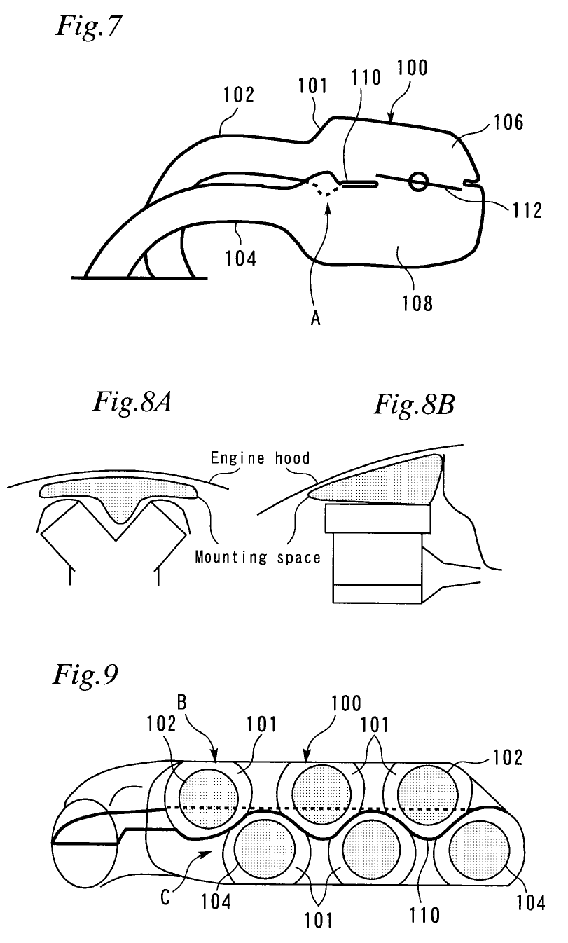

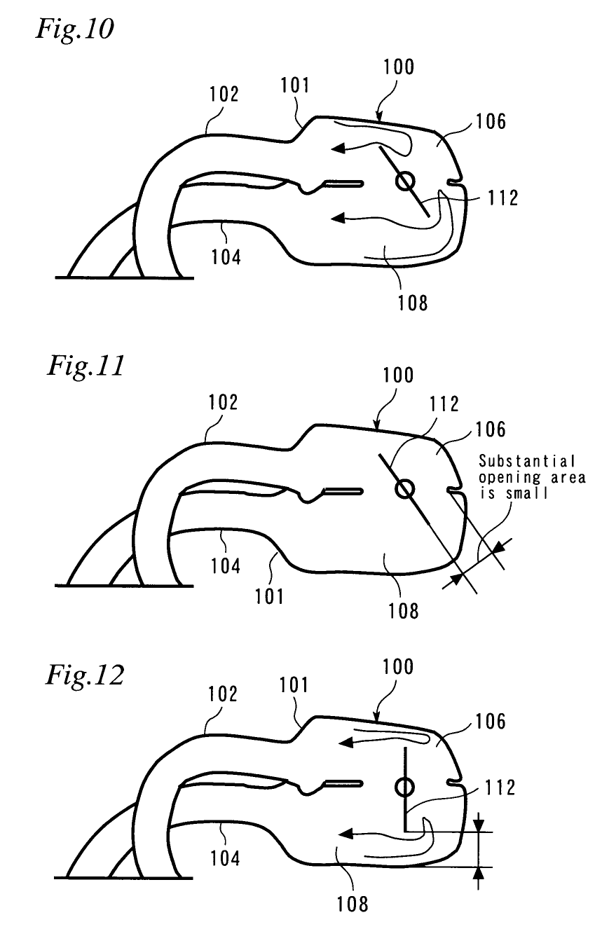

FIG. 6 compares the condition, in which the first variable valve 34 and the second variable valve 36 are closed, with the condition, in which the first variable valve 34 and the second variable valve 36 are open. Crosshatched portions in FIG. 6 represent effective volume portions of the first space 24 and the second space 26. In accordance with the first embodiment of the present invention, referring to FIG. 6, both the first variable valve 34 and the second variable valve 36 are closed when the engine is in a low to middle speed region and the first variable valve 34 and the second variable valve 36 are open when the engine is in a high speed region.

### (Low to Middle Speed Region)

Referring to FIG. 6, when the first variable valve 34 is closed, only a portion to the left of the first variable valve 34 in FIG. 6 is the effective volume of the first space 24. Similarly, when the second variable valve 36 is closed, only a portion to the left of the second variable valve 36 in FIG. 6 is the effective volume of the second space 26. In addition, when the first variable valve 34 and the second variable valve 36 are closed, the effective volume portion of the first space 24 and the effective volume portion of the second space 26 are separated from each other by the partition plate 28. As such, when the first variable valve 34 and the second variable valve 36 are closed, the effective volume portion of the first space 24 and the effective volume portion of the second space 26 are each a small volume and separated from each other by the partition plate 28, so that each functions as an independent surge tank. A substantial tank volume can therefore be made sufficiently small, so that an engine torque in the low to middle speed region can be sufficiently improved and response can be improved.

### (High Speed Region)

On the other hand, when the first variable valve 34 is open, the first space 24 is entirely the effective volume. Similarly, when the second variable valve 36 is open, the second space 26 is entirely the effective volume. In addition, when both the first variable valve 34 and the second variable valve 36 are open, the effective volume portion of the first space 24 and the effective volume portion of the second space 26 are in communication with each other through an opening 30. As such, when the first variable valve 34 and the second variable valve 36 are open, the effective volume portion of the first space 24 and the effective volume portion of the second space 26 are each become a large volume and in communication with each other through the opening 30, so that both function integrally as a large surge tank. Accordingly, pulsation effect between cylinders is enhanced and the substantial tank volume can be made substantially large, thus allowing the engine torque in the high speed region to be sufficiently improved.

Referring to FIG. 5, in accordance with the first embodiment of the present invention, when the first variable valve 34 and the second variable valve 36 are open, vanes of the first variable valve 34 and the second variable valve 36 are substantially in parallel with the partition plate 28. Specifically, the vanes of the first variable valve 34 and the second variable valve 36 are substantially in parallel with an air flow in the surge tank 14. Consequently, when the first variable valve 34 and the second variable valve 36 are open, the vanes of the first variable valve 34 and the second variable valve 36 can be sufficiently prevented from serving as the suction resistance. The air intake efficiency can therefore be enhanced.

The first embodiment of the present invention has been described as applied to the V-type 6-cylinder engine. The applicable engine type is not, however, limited to one having six cylinders. In addition, the cylinder arrangement is not limited to the V-type, either; the present invention is also applicable to, for example, a horizontally opposed engine.

Aspects of the present invention described above and the major benefits thereof are summarized as follows:

A first aspect of the present invention relates to an air intake device for a multi-cylinder internal combustion engine having two cylinder banks. The air intake device includes a tank having an internal space divided into a first space and a second space disposed downwardly of the first space, and a partition plate and an opening disposed at a boundary between the first and second spaces; a first intake manifold including a plurality of intake branch pipes protruding from the tank via a funnel and communicating with the first space, the first intake manifold supplying air to cylinders on a first of the two cylinder banks; and a second intake manifold including a plurality of intake branch pipes protruding from the tank via a funnel and communicating with the second space, the second intake manifold supplying air to cylinders on a second of the two cylinder banks. The funnel has a substantially rectangular transverse cross-sectional shape.

A second aspect of the present invention relates to the air intake device according to the first aspect. In this device, the intake branch pipes have a substantially rectangular transverse cross-sectional shape.

A third aspect of the present invention relates to the air intake device according to the second aspect. In this device, a space between the intake branch pipes includes a gap formed therein, into which a tool for tightening bolts connecting the intake branch pipes to a part connected on a downstream side of the intake branch pipes can be inserted.

A fourth aspect of the present invention relates to the air intake device according to the first aspect. In this device, the partition plate is shaped flatly at an area near the funnel.

A fifth aspect of the present invention relates to the air intake device according to the first aspect. This device further includes a first variable valve disposed in the first space and displaced between a closed position, in which an effective volume of the first space is small, and an open position, in which the effective volume of the first space is large; and a second variable valve disposed in the second space and displaced between a closed position, in which an effective volume of the second space is small, and an open position, in which the effective volume of the second space is large.

A sixth aspect of the present invention relates to an air intake device for a multi-cylinder internal combustion engine having two cylinder banks. This air intake device includes a tank having an internal space divided into a first space and a second space, and a partition plate and an opening disposed at a boundary between the first and second spaces; a first intake manifold including a plurality of intake branch pipes protruding from the tank and communicating with the first space, the first intake manifold supplying air to cylinders on a first of the two cylinder banks; a second intake manifold including a plurality of intake branch pipes protruding from the tank and communicating with the second space, the second intake manifold supplying air to cylinders on a second of the two cylinder banks; a first variable valve disposed in the first space and displaced between a closed position, in which an effective volume of the first space is small, and an open position, in which the effective volume of the first space is large; and a second variable valve disposed in the second space and displaced between a closed position, in which an effective volume of the second space is small, and an open position, in which the effective volume of the second space is large.

A seventh aspect of the present invention relates to the air intake device according to the sixth aspect. In this device, when the first variable valve and the second variable valve are in the closed position, an effective volume portion of the first space and an effective volume portion of the second space are separated from each other by the partition plate. And, in this device, when the first variable valve and the second variable valve are in the open position, the effective volume portion of the first space and the effective volume portion of the second space are in communication with each other via the opening.

A eighth aspect of the present invention relates to the air intake device according to the sixth aspect. In this device, when the first variable valve and the second variable valve are in the open position, vanes of the first variable valve and the second variable valve are brought into a position of extending substantially in parallel with the partition plate.

In accordance with the first aspect of the present invention, the air intake device comprises the tank having the internal space divided into the upward first space and the downward second space, the first intake manifold supplying air in the first space to cylinders on the first of the two cylinder banks, and the second intake manifold supplying air in the second space to cylinders on the second of the two cylinder banks. In the air intake device, the funnel disposed at a root of each intake branch pipe can be adapted to have a substantially rectangular transverse cross-sectional shape. This arrangement prevents a space for disposing each funnel from overlapping each other even if the surge tank is adapted to have a low height (thinning). This allows the partition plate separating the first space from the second space to be shaped so as to minimize suction resistance, so that air intake efficiency of the engine can be improved. Because there is no overlap between the funnels, each funnel can have a uniform taper throughout its entire periphery. This also contributes to reduction in the suction resistance. Pulsation of each cylinder can also be made stronger and uniform. As such, the air intake device according to the first aspect of the present invention can achieve both a reduced thickness of the surge tank and improved air intake efficiency. Accordingly, an engine hood of a vehicle can be made lower and the degree of freedom in styling can be enhanced. It is also possible to provide an impact absorbing space in an engine compartment, promoting pedestrian protection.

In accordance with the second aspect of the present invention, the intake branch pipes have a substantially rectangular transverse cross-sectional shape. The intake branch pipes can have smaller vertical and horizontal widths as compared with a circular transverse cross-sectional shape. As a result, the intake branch pipes can have a milder curve and, therefore, the air intake efficiency can be improved.

In accordance with the third aspect of the present invention, the arrangement, in which the intake branch pipes have the substantially rectangular transverse cross-sectional shape, allows a curve provided for the intake branch pipes for forming a gap, into which a tool is to be inserted, to be made mild. The air intake efficiency can therefore be improved.

In accordance with the fourth aspect of the present invention, the partition plate is shaped flatly at the area near the funnel. This achieves a further reduction in the suction resistance from the surge tank to each intake branch pipe. The air intake efficiency of the engine can therefore be further improved.

In accordance with the fifth aspect of the present invention, in a low to middle speed region of the engine, the first variable valve and the second variable valve are closed, so that the effective volume of the first space and that of the second space are both small and each functions as an independent surge tank. Accordingly, a substantial tank volume can be made sufficiently small, so that an engine torque in the low to middle speed region can be sufficiently improved and response can be improved. In a high speed region of the engine, on the other hand, both the first variable valve and the second variable valve are opened, so that the effective volume of the first space and that of the second space become both large and both are in communication with each other through the opening. Both the first space and the second space then function integrally as a large surge tank. Accordingly, pulsation effect between cylinders is enhanced and the substantial tank volume can be made substantially large, thus allowing the engine torque in the high speed region to be sufficiently improved.

In accordance with the sixth aspect of the present invention, in a low to middle speed region of the engine, the first variable valve and the second variable valve are closed, so that the effective volume of the first space and that of the second space are both small and each functions as an independent surge tank. Accordingly, a substantial tank volume can be made sufficiently small, so that an engine torque in the low to middle speed region can be sufficiently improved and response can be improved. In a high speed region of the engine, on the other hand, both the first variable valve and the second variable valve are opened, so that the effective volume of the first space and that of the second space become both large and both are in communication with each other through the opening. Both the first space and the second space then function integrally as a large surge tank. Accordingly, pulsation effect between cylinders is enhanced and the substantial tank volume can be made substantially large, thus allowing the engine torque in the high speed region to be sufficiently improved.

In accordance with the seventh aspect of the present invention, when the first variable valve and the second variable valve are in the closed position, the effective volume portion of the first space and the effective volume portion of the second space are separated from each other by the partition plate. When the first variable valve and the second variable valve are in the open position, on the other hand, the effective volume portion of the first space and the effective volume portion of the second space are in communication with each other via the opening. The foregoing effect can therefore be achieved with a simple structure.

In accordance with the eighth aspect of the present invention, when the first variable valve and the second variable valve are in the open position, vanes of the first variable valve and the second variable valve are brought into a position of extending substantially in parallel with the partition plate. Specifically, the vanes of the first variable valve and the second variable valve are substantially in parallel with an air flow in the surge tank. Consequently, when the first variable valve and the second variable valve are open, the vanes of the first variable valve and the second variable valve can be sufficiently prevented from serving as the suction resistance. The air intake efficiency can therefore be enhanced.

1. An air intake device for a multi-cylinder internal combustion engine having two cylinder banks, the air intake device comprising:
a tank having an internal space divided into a first space and a second space disposed downwardly of the first space, and a partition plate and an opening disposed at a boundary between the first and second spaces;
a first intake manifold including a plurality of intake branch pipes protruding from the tank via a funnel and communicating with the first space, the first intake manifold supplying air to cylinders on a first of the two cylinder banks; and
a second intake manifold including a plurality of intake branch pipes protruding from the tank via a funnel and communicating with the second space, the second intake manifold supplying air to cylinders on a second of the two cylinder banks;
wherein the funnel has a substantially rectangular transverse cross-sectional shape.

2. The air intake device according to claim 1, wherein the intake branch pipes have a substantially rectangular transverse cross-sectional shape.

3. The air intake device according to claim 2, wherein a space between the intake branch pipes includes a gap formed therein, into which a tool for tightening bolts connecting the intake branch pipes to a part connected on a downstream side of the intake branch pipes can be inserted.

4. The air intake device according to claim 1,
wherein the partition plate is shaped flatly at an area near the funnel.

5. The air intake device according to claim 1, further comprising:
a first variable valve disposed in the first space and displaced between a closed position, in which an effective volume of the first space is small, and an open position, in which the effective volume of the first space is large; and
a second variable valve disposed in the second space and displaced between a closed position, in which an effective volume of the second space is small, and an open position, in which the effective volume of the second space is large.

6. An air intake device for a multi-cylinder internal combustion engine having two cylinder banks, the air intake device comprising:
a tank having an internal space divided into a first space and a second space, and a partition plate and an opening disposed at a boundary between the first and second spaces;
a first intake manifold including a plurality of intake branch pipes protruding from the tank and communicating with the first space, the first intake manifold supplying air to cylinders on a first of the two cylinder banks;
a second intake manifold including a plurality of intake branch pipes protruding from the tank and communicating with the second space, the second intake manifold supplying air to cylinders on a second of the two cylinder banks;
a first variable valve disposed in the first space and displaced between a closed position, in which an effective volume of the first space is small, and an open position, in which the effective volume of the first space is large; and
a second variable valve disposed in the second space and displaced between a closed position, in which an effective volume of the second space is small, and an open position, in which the effective volume of the second space is large.

7. The air intake device according to claim 6,
wherein, when the first variable valve and the second variable valve are in the closed position, an effective volume portion of the first space and an effective volume portion of the second space are separated from each other by the partition plate; and
wherein, when the first variable valve and the second variable valve are in the open position, the effective volume portion of the first space and the effective volume portion of the second space are in communication with each other via the opening.

8. The air intake device according to claim 6,
wherein, when the first variable valve and the second variable valve are in the open position, vanes of the first variable valve and the second variable valve are brought into a position of extending substantially in parallel with the partition plate.
